(19) United States
(12) Patent Application Publication
(10) Pub. No.: US 2019/0171219 A1
(43) Pub. Date: Jun. 6, 2019

(54) AUTOMATED GUIDED VEHICLE

(71) Applicant: HONDA MOTOR CO., LTD., Tokyo (JP)

(72) Inventors: Susumu Akutsu, Tochigi (JP); Makoto Tanaka, Tochigi (JP)

(21) Appl. No.: 16/202,376

(22) Filed: Nov. 28, 2018

(30) Foreign Application Priority Data
Dec. 1, 2017 (JP) 2017-232134

(51) Int. Cl. G05D 1/02; G05D 1/00

(52) U.S. Cl. CPC G05D 1/0223; G05D 1/0088

(57) ABSTRACT

The automated guided vehicle including a body, left and right tires, a guide sensor provided on the body to detect the guide marker, and a drive unit which drives the left and right tires. The drive unit executes a first control in which the left and right tires are driven so that the automated guided vehicle travels parallel to an extending direction of the guide marker when the automated guided vehicle travels in a direction travelling away from the guide marker, and executes a second control in which the left and right tires are driven so that a reference position on the body of the automated guided vehicle shifts onto the guide marker and travels along the guide marker when the automated guided vehicle travels parallel to the extending direction of the guide marker or travels towards the guide marker.

### BACKGROUND OF THE INVENTION

### Field of the Invention

The present invention relates to an automated guided vehicle running on a track.

### Description of the Related Art

An Automated Guided Vehicle (AGV) running on a track is controlled to move with its center following a magnetic guide marker laid out along, for example, an operation line. A magnetic sensor configured to detect the magnetic guide marker is disposed on the automated guided vehicle. The magnetic sensor is disposed to detect, for example, an area lying ahead of and below the automated guided vehicle in a traveling direction while spreading 70 mm to the left and right from the center of the vehicle.

For example, in an automated guided vehicle having two tires individually disposed on the left and right sides of the vehicle and a pair of motors configured to drive the corresponding tires, the motors are controlled through a “rectangular wave control” by use of an angle sensor employing a “Hall element” without using a current sensor.

As a drive device for controlling two motors synchronously, for example, a drive device is proposed in which a driving speed of a first drive shaft and a driving speed of a second drive shaft are controlled so that a driving position of a first motor and a driving position of a second motor do not deviate from predetermined ranges, respectively (for example, refer to Japanese Patent No. 6092701). Additionally, there is proposed a synchronous controller which selects, as a position correction amount, a position correction amount, which is calculated independently for each of the shafts, so as to meet the most slow shaft to maintain the synchronization of the shafts highly accurately (for example, refer to Japanese Patent No. 5388605).

In the conventional motor control, the gain is determined so that the automated guided vehicle does not oscillate assuming a lightest state of the load to be connected. With the automated guided vehicle running on the track, however, depending upon whether or not goods are loaded on it, the load on the automated guided vehicle fluctuates largely. Then, with the gain determined in the way described above, the automated guided vehicle only operates slowly when a heaviest load is loaded. In addition, the steeper the initial angle of the body of the automated guided vehicle, the radius of curvature, or the angle of a corner, the smaller the speed of the automated guided vehicle is set so that the automated guided vehicle is restrained from deviating from its guide path, causing a problem in that the automated guided vehicle is forced to operate more slowly.

In the automated guided vehicle having the angle sensor employing the Hall element as described above, it is considered to use a method employing a pseudo-sine wave to enhance the speed responsiveness and the steady-state stability. Even though method is used, however, the rising acceleration responsiveness is limited, and since no command equal to or larger than the responsiveness of the motor can be inputted, the vehicle still operates slowly.

In operating the automated guided vehicle, briefly speaking, there are two types of guided operations. A first guided operation is a “towing guided operation” in which the automated guided vehicle tows a cart, and a second guided operation is a “carrying-on-back guided operation” in which the automated guided vehicle crawls into under a cart to carry the cart on it. In these two guided operations, although the control systems and the variations in conveyable weight differ largely, the constant control is demanded in relation to the control gain in controlling the acceleration/deceleration time and the maximum speed of the automated guided vehicle and the correction for deviation of the automated guided vehicle from the magnetic guide marker.

In the “towing guided operation,” however, even though the gain of the automated guided vehicle is increased slightly, the automated guided vehicle keeps running on the line without deviating from the line. On the other hand, in the “carrying-on-back guided operation,” since the center of gravity of the cart almost coincides with the center of gravity of the automated guided vehicle, with the same gain as that for the towing guided operation, the automated guided vehicle undesirably oscillates or deviates from the line (the guide path). On the contrary, when the gain is decreased, the desirable acceleration cannot be obtained, whereby the conveyance time is extended.

The present invention has been made in view of the situations described above, and one of objects of the present invention is to provide an automated guided vehicle configured to run quickly while preventing it from deviating from its guided traveling path.

### SUMMARY OF THE INVENTION

An automated guided vehicle according to the present invention is an automated guided vehicle running along a guide marker, the automated guided vehicle comprising: a body; left and right tires; a guide sensor provided on the body and configured to detect the guide marker; and a drive unit configured to drive the left and right tires, wherein the drive unit executes a first control in which the left and right tires are driven so that the automated guided vehicle travels in a direction parallel to an extending direction of the guide marker in a case where the automated guided vehicle travels in a direction in which the automated guided vehicle travels away from the guide marker, and a second control in which the left and right tires are driven so that a reference position on the body of the automated guided vehicle shifts onto the guide marker and that the automated guided vehicle travels along the guide marker in a case where the automated guided vehicle travels in a direction parallel to the extending direction of the guide marker or travels in a direction in which the automated guided vehicle travels towards the guide marker.

In this way, with the automated guided vehicle of the present invention, when the automated guided vehicle travels in the direction in which the automated guided vehicle travels away from the guide marker, the two-stage control is executed in which firstly, the traveling direction of the automated guided vehicle is controlled to be parallel to the guide marker, and then, the automated guided vehicle is shifted onto the guide marker from the state where the automated guided vehicle is parallel to the guide marker. According to the two-stage control, being different from a case where the automated guided vehicle which is traveling in the direction in which the automated guided vehicle travels away from the guide marker is attempted to be shifted onto the guide marker through a single operation, there is generated no large transverse inertia that would otherwise be generated by a drastic change in the traveling direction of the body. Consequently, the automated guided vehicle can be prevented from deviating from the guide path. Additionally, since the set speed of the automated guided vehicle does not have to be suppressed to a low level for the sake of preventing the automated guided vehicle from deviating from the guide path, the automated guided vehicle can be restrained from deviating from the guide path while allowing the automated guided vehicle to act quickly.

In addition, preferably, in the second control, the drive unit drives the left and right tires so that an angle formed by the traveling direction of the automated guided vehicle and the extending direction of the guide marker decreases according to a distance between the body of the automated guided vehicle and the guide marker.

According to this configuration, in the second control, the automated guided vehicle is controlled so that the traveling direction gradually coincides with the extending direction of the guide marker as the automated guided vehicle travels towards the guide marker. Due to this, being different from a case where the traveling direction of the automated guided vehicle is controlled drastically so that the automated guided vehicle is shifted onto the guide marker, no oscillating state is generated. Consequently, the deviation of the automated guided vehicle from the guide path due to the oscillation of the body can be prevented.

The drive unit preferably comprises: a pair of motors configured to drive the left and right tires; a body position detection unit configured to obtain a body angle signal indicating a change in a position of the body of the automated guided vehicle with respect to the guide marker; a speed command calculation unit configured to set a target angle of the body and calculate speed command values for the left and right tires based on the set target angle of the body and the body angle signal; and an output speed calculation processing unit configured to calculate speed command values for the pair of motors based on the speed command values of the left and right tires.

According to this configuration, speed command values according to the target angle can be calculated by feedback controlling the change in the position of the body relative to the guide marker with respect to the target angle of the body.

Preferably, the output speed calculation processing unit calculates a forced tracing speed command value based on a mean of actual speeds of the left and right tires, the position of the body of the automated guided vehicle with respect to the guide marker and a mean of speed command values of the left and right tires, and calculates speed command values for the pair of motors based on the speed command values of the left and right tires, the forced tracing speed command value, and the actual speeds of the left and right tires.

According to this configuration, being different from a case where the command values for the motors are calculated only through the feedback control, the speed command equal to or larger than the response characteristic of the motors can be executed by adding the forced tracing command value. This enables the control to prevent the deviation of the automated guided vehicle from the track to be realized while suppressing the deceleration of the body to a minimum level by inputting the steep speed command into the motors.

When the automated guided vehicle runs on a curved path, the output speed calculation processing unit preferably calculates the speed command values for the pair of motors by setting a large acceleration/deceleration gain for the tire of the left and right tires positioned on a radially outer side of the curved path and a small acceleration/deceleration gain for the tire positioned on a radially inner side of the curved path.

According to this configuration, when the automated guided vehicle runs on a curved path such as a curb, the automated guided vehicle can be made to act with a smaller turning radius by increasing the change in speed of the radially outer side tire while decreasing the change in speed of the radially inner side tire, or decelerating the same tire. Thus, since the responsiveness of the body can be enhanced, the automated guided vehicle can run quickly.

Additionally, even when the automated guided vehicle is accelerated or decelerated in association with a stop on the curved path such as a curb, the automated guided vehicle can stop or start without deviating from the traveling path.

### BRIEF DESCRIPTION OF THE DRAWINGS

FIG. 1 is a block diagram illustrating the configuration of a motor control system according to an embodiment of the prevent invention;

FIG. 2 is a drawing illustrating schematically a bottom surface of a body of an automated guided vehicle;

FIG. 3A illustrates a positional relationship between the automated guide vehicle and a magnetic guide marker near a curve;

FIG. 3B illustrates a speed vector of the automated guided vehicle;

FIG. 3C illustrates an expression for calculating a speed vector;

FIG. 4A illustrates a target angle of the body when a traveling direction of the automated guided vehicle is a direction in which the automated guided vehicle travels towards the magnetic guide marker;

FIG. 4B illustrates a target angle of the body when the traveling direction of the automated guided vehicle is a direction in which the automated guided vehicle travels away from the magnetic guide marker;

FIGS. 5A to 5D illustrate relationships between traveling directions of the automated guided vehicle and target angles of the body;

FIG. 6 is a diagram representing a control process of an output speed calculation process; and

FIG. 7 illustrates graphs depicting schematically relationships among a position of the automated guided vehicle, a left speed command, an actual speed of a left tire, a right speed command, and an actual speed of a right tire.

### DETAILED DESCRIPTION OF THE PREFERRED EMBODIMENT

Hereinafter, referring to drawings, an embodiment of the present invention will be described. In the following description and accompanying drawings of the embodiment, like reference signs are given to substantially like or equivalent portions.

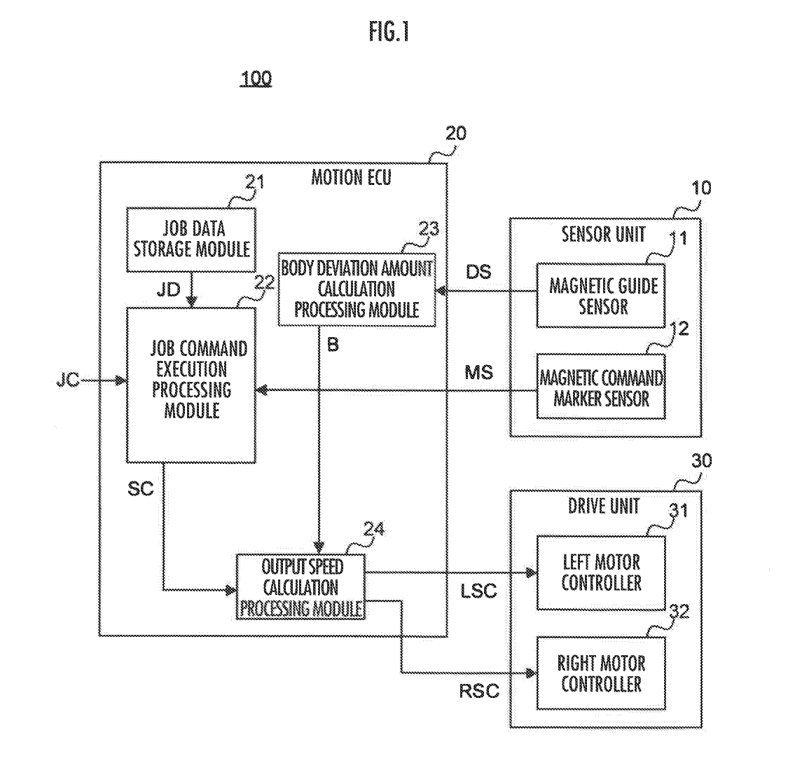

FIG. 1 is a block diagram illustrating the configuration of a motor control system 100 according to the embodiment. The motor control system 100 is a control system configured to control a motor of an Automated Guided Vehicle (AGV). The motor control system 100 comprises a sensor unit 10, a motion Electronic Control Unit (ECU) 20, and a motor drive unit 30. The sensor unit 10, the motion ECU 20 and the drive unit 30 are mounted on the automated guided vehicle AGV.

The sensor unit 10 includes a magnetic guide sensor 11. The magnetic guide sensor 11 is provided on a body bottom surface of the automated guided vehicle AGV.

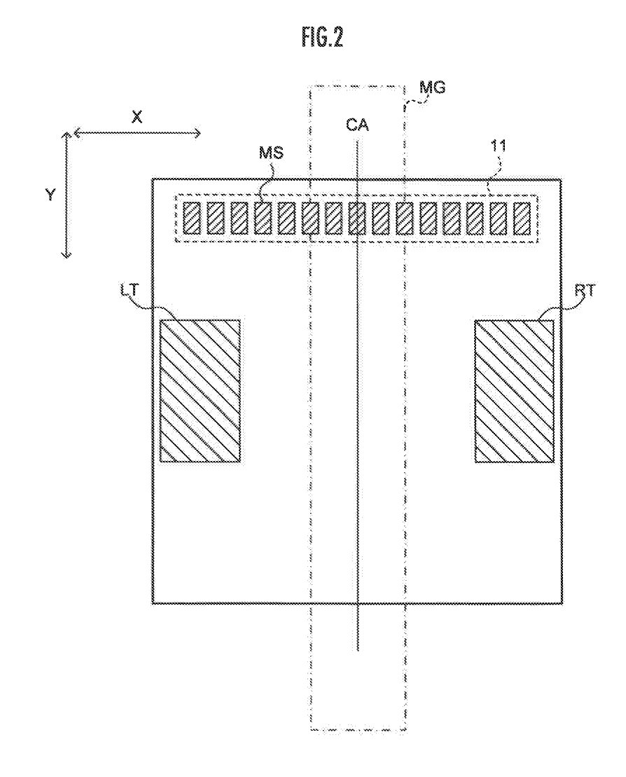

FIG. 2 is a drawing illustrating schematically a bottom surface of a body of the automated guided vehicle AGV. In FIG. 2, an X direction denotes a direction perpendicular to a traveling direction of the automated guided vehicle AGV, and a Y direction denotes a direction along the traveling direction of the automated guided vehicle AGV. A left tire LT is provided on a left side and a right tire RT is provided on a right side of the body of the automated guided vehicle AGV. A tape-shaped magnetic guide marker MG (that is, a guide tape indicating an operation route) is laid out on a path surface of the operation route (a guide path) of the automated guided vehicle AGV.

The guide sensor 11 is configured as a magnetic sensor array made up of a plurality of magnetic sensors MS aligned in a direction which intersects a center axis CA of the body of the automated guided vehicle AGV. In this embodiment, with a center magnetic sensor MS disposed on the center axis CA, seven magnetic sensors MS are aligned at intervals of 10 mm on a left side of the center axis CA (that is, in the X direction in FIG. 2), and another seven magnetic sensors MS are aligned at intervals of 10 mm on a right side of the center axis CA (that is, in the X direction in FIG. 2). Thus, in total, 15 magnetic sensors MS are aligned in a row in a direction perpendicular to the center axis CA. Consequently, the magnetic sensor 11 of this embodiment is configured as the magnetic sensor array configured to cover a width of 140 mm in a left-and-right direction.

The magnetic guide sensor 11 generates a magnetic detection signal DS indicating whether or not each of the magnetic sensors MS detects magnetism at a predetermined level or higher (that is, whether the detection of each of the magnetic sensors MS is ON or OFF) and sends the generated magnetic detection signal DS to the motion ECU 20. Which magnetic sensor MS becomes ON (or OFF) changes depending upon a positional relationship between the center axis CA of the automated guided vehicle AGV and the magnetic guide marker MG (the position and the angle). Consequently, the magnetic detection signal DS constitutes a signal indicating the positional relationship between the center axis CA of the automated guided vehicle AGV and the magnetic guide marker MG.

Referring again to FIG. 1, the sensor unit 10 includes a magnetic command marker sensor 12. The magnetic command marker sensor 12 is a magnetic sensor configured to detect a magnetic command marker (not illustrated) which is provided at a predetermined point (for example, in a position along a curve or a position where the automated guided vehicle AGV is designed to stop) on the operation route of the automated guided vehicle AGV. The magnetic command marker sensor 12 is provided separately from the magnetic guide sensor 11 on the body bottom surface of the automated guided vehicle AGV. The magnetic command marker sensor 12 supplies a magnetic command marker detection signal MS to the motion ECU 20 according to the detection of the magnetic command marker.

The motion ECU 20 has a job data storage module 21, a job command execution processing module 22, a body deviation amount calculation processing module 23, and an output speed calculation processing module 24.

The job data storage module 21 stores a job data JD indicating the contents of a job command which is to be executed by the job command execution processing module 22 The job data includes a body speed command for the automated guided vehicle AGV. The job data JD is updated as required by, for example, a host system outside the vehicle.

The job command execution processing module 22 reads out the job data JD from the job data storage module 21 and executes a job command indicated by the job data JD according to a job execution start command JC from the host system (not illustrated) outside the vehicle. For example, the job command execution processing module 22 sets a body target angle θcom and supplies a speed command SC corresponding to the body target angle θcom to the output speed calculation processing module 24.

Additionally, the job command execution processing module 22 receives a magnetic command marker detection signal MS supplied from the magnetic command marker sensor 12 and switches the contents of the job command. For example, when receiving a magnetic command marker detection signal MS in the midst of executing a job command in a first step, the job command execution processing module 22 reads in a job command in the next step from the job data JD and executes the job command in a second step.

The body deviation amount calculation processing module 23 calculates a deviation amount of the body of the automated guided vehicle AGV with respect to the magnetic guide marker MG based on a magnetic detection signal DS supplied from the magnetic guide sensor 11. The body deviation amount calculation processing module 23 supplies the body deviation amount obtained through the calculation to the output speed calculation module 24 as a positional deviation amount B.

The output speed calculation processing module 24 calculates speed commands for the left and right motors based on the body speed command SC supplied from the job command execution processing module 22, the positional deviation amount B supplied from the body deviation amount calculation processing module 23, and an actual speed AS of the automated guided vehicle AGV. The output speed calculation processing module 24 supplies a left speed command LSC and a right speed command RSC which are obtained through the calculation to the drive unit 30.

The drive unit 30 includes a left motor controller 31 and a right motor controller 32. The left motor controller 31 is a motor control module configured to control a left motor (not illustrated) connected to the left tire LT illustrated in FIG. 2. The right motor controller 32 is a motor control module configured to control a right motor (not illustrated) connected to the right tire RT illustrated in FIG. 2. The left motor controller 31 changes the speed of the left tire LT by rotationally driving the left motor based on the left speed command LSC. The right motor controller 32 changes the speed of the right tire RT by rotationally driving the right motor based on the right speed command RSC.

The motor control system 100 of this embodiment controls the speeds of the left tire and the right tire RT (that is, controls the running of the automated guided vehicle AGV) to enable the automated guide vehicle AGV to run on the magnetic guide marker MG (that is, on the operation route).

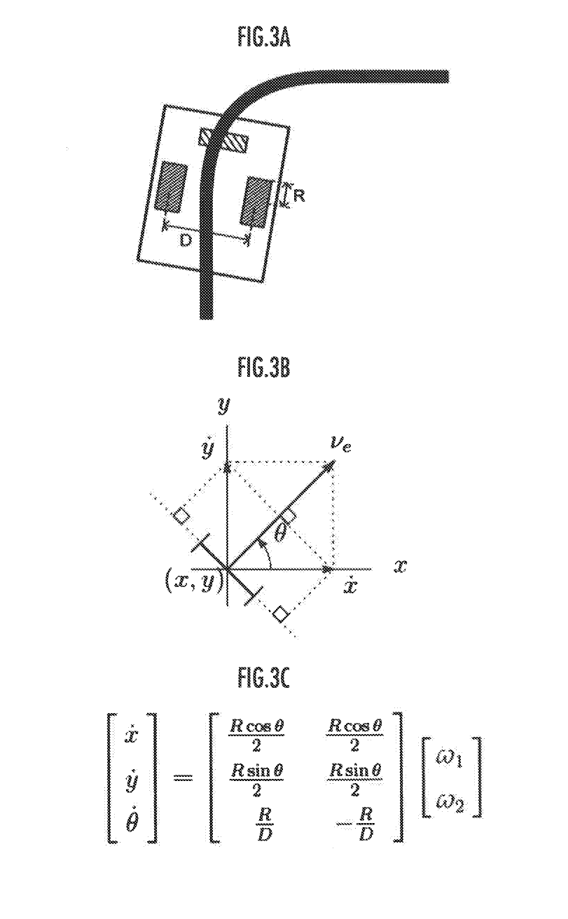

FIG. 3A is a drawing illustrating schematically a positional relationship between the automated guided vehicle AGV and the magnetic guide marker MG near a curve on the operation route. A speed vector Ve of the automated guided vehicle AGV is represented, as illustrated in FIG. 3B, by a speed in the X direction, a speed in the Y direction, and an angle θ. Then, the speed vector Ve is expressed by a calculation expression illustrated in FIG. 3C, where R denotes a radius of the tire, and D denotes a distance between the left tire LT and the right tire RT.

In this way, the speed of the automated guided vehicle AGV includes the angle parameter. Then, the motor control system 100 of this embodiment controls the running of the automated guided vehicle AGV by setting the body target angle θcom, which corresponds to the traveling direction of the automated guided vehicle AGV, and controlling the speeds of the left tire LT and the right tire RT according to the set body target angle θcom. The body target angle θcom is expressed by “θcom=(K/R)×B,” where K denotes proportional constant, R denotes motor revolution speed, and B denotes deviation amount.

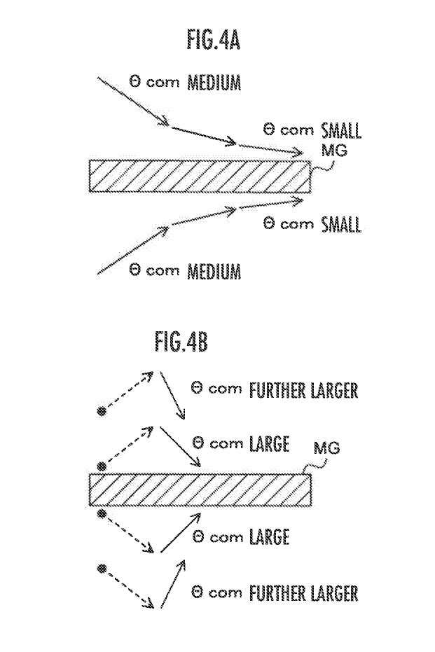

The body target angle θcom is set dynamically according to the traveling of the automated guided vehicle AGV. For example, in the case where the traveling direction of the automated guided vehicle AGV follows the magnetic guide marker MG, as illustrated in FIG. 4A, the body target angle θcom is firstly set at a medium value, which is reduced gradually to take a smaller value as the automated guided vehicle AGV travels. On the other hand, in the case where the automated guided vehicle AGM travels in a direction in which the automated guided vehicle AGV travels away from the magnetic guide marker MG as illustrated in FIG. 4B, the body target angle θcom is set at a large value. In addition, in the case where the automated guided vehicle AGV is situated far away from the magnetic guide marker MG, the body target angle θcom is set at a larger value.

The motor control system 100 of this embodiment controls the motor in two stages when the automated guided vehicle AGV travels in the direction in which the automated guided vehicle AGV travels away from the magnetic guide marker MG.

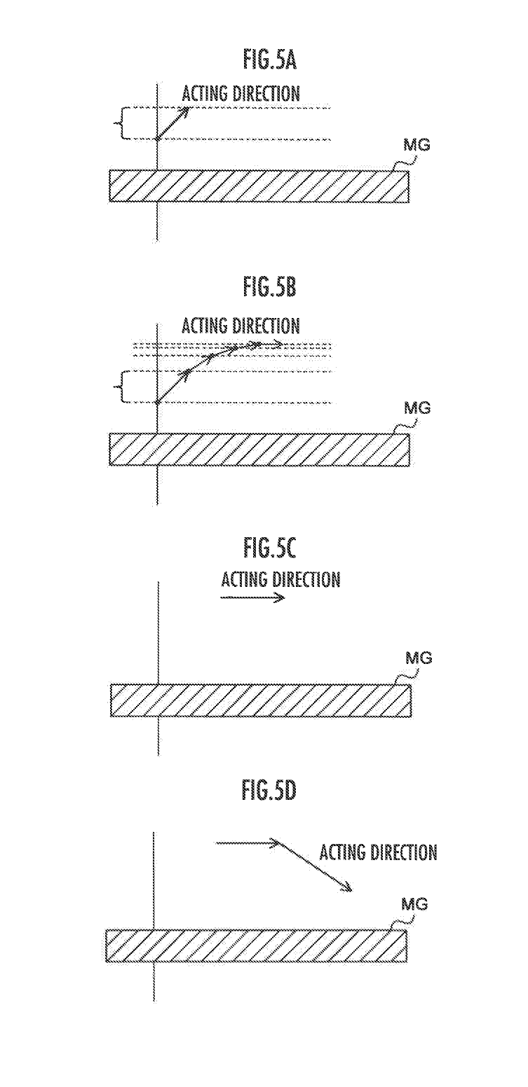

In a control in a first stage, a detection position at a point in time when the automated guided vehicle AGV starts is referred to as an offset position, and the motor control system 100 controls so that the traveling direction of the automated guided vehicle AGV converges to the offset position. For example, as shown in FIG. 5A, the body target angle θcom is set so that the traveling direction of the automated guided vehicle AGV coincides with a direction in which the magnetic guide marker MG extends. Then, a large gain is set so that even when the automated guided vehicle AGV acts with a maximum load, the automated guided vehicle AGV does not deviate from the magnetic guide marker MG for execution of a Proportional Integral Differential (PID) Controller.

As shown in FIG. 5B, when the traveling direction of the automated guided vehicle AGV becomes parallel to the extending direction of the magnetic guide marker MG, the motor control system 100 once resets the control parameter and shifts to a control in a second stage.

In the control in the second stage, the body target angle θcom is set so that a center of the magnetic sensor 11 of the automated guided vehicle AGV moves onto the magnetic guide marker MG for execution of control of the motors. That is, the body target angle θcom is set so that a state where the automated guided vehicle AGV is traveling in the direction parallel to the extending direction of the magnetic guide marker MG as illustrated in FIG. 5C shifts to a state where the automated guided vehicle AGV travels towards the magnetic guide marker MG as illustrated in FIG. 5D, and a small gain is set so that the automated guided vehicle AGV moves stably with no load applied to it for execution of the PID control. That is, the motor control system 100 of this embodiment executes a first control (the control in the first stage) in which the left and right tires are driven to cause the automated guided vehicle AGV to travel in the direction parallel to the extending direction of the magnetic guide marker MG when the automated guided vehicle AGV is traveling in a direction in which the automated guided vehicle AGV travels away from the magnetic guide marker MG, while the motor control system 100 executes a second control (the control in the second stage) in which the left and right tires are driven so that a predetermined reference position (not illustrated) on the body of the automated guided vehicle AGV shifts onto the magnetic guide marker MG and the automated guided vehicle AGV travels along the magnetic guide marker MG when the automated guided vehicle is traveling in the direction parallel to the extending direction of the magnetic guide marker MG or in a direction in which the automated guided vehicle AGV travels towards the magnetic guide marker MG. Then, in the control in the second stage, the left and right tires are driven so that an angle formed by the traveling direction of the automated guided vehicle AGV and the extending direction of the magnetic guide marker MG becomes smaller according to a distance between the body of the automated guided vehicle AGV and the magnetic guide marker MG.

On the other hand, when the automated guided vehicle AGV travels parallel to the extending direction of the magnetic guide marker MG or towards the magnetic guide marker MG, only the control in the second stage is executed. This enables the body target angle θcom to be set flexibly according to the traveling direction of the body of the automated guided vehicle AGV for execution of the required control.

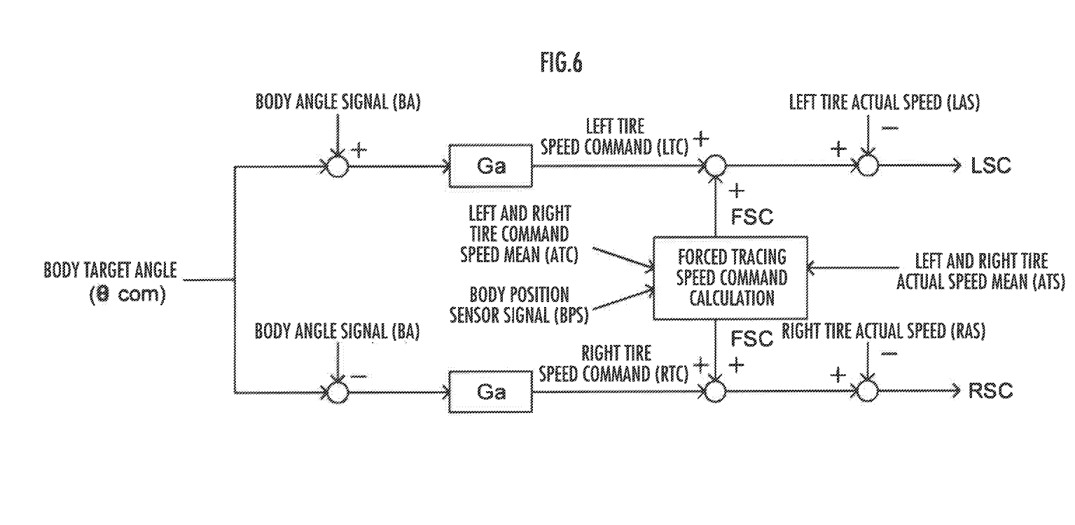

Next, referring to FIG. 6, a control process for an output speed calculation process of calculating a left speed command LSC and a right speed command RSC which are used in controlling the left and right motors based on the set body target angle θcom. Here, the automated guided vehicle AGV will be described as running along a rightward curve as illustrated in FIG. 3A.

As has been described above, the output speed calculation processing module 24 calculates a left speed command LSC and a right speed command RSC based on the body speed command SC supplied from the job command execution processing module 22, the positional deviation amount B supplied from the body deviation amount calculation processing module 23, and the actual speed AS of the automated guided vehicle AGV.

Firstly, the output speed calculation processing module 24 obtains a body position sensor signal BPS indicating the body position of the automated guided vehicle AGV from the sensor unit 10. Further, the output speed calculation processing module 24 obtains a left tire actual speed LAS indicating an actual speed of the tire LT and a right tire actual speed RAS indicating an actual speed of the right tire RT.

The output speed calculation processing module 24 calculates a body angle signal BA. The body angle signal BA is calculated by an expression: K3× variation rate of body position sensor signal BPS× actual speed AS. K3denotes a constant set by a sensor resolution and a sampling cycle.

The output speed calculation processing module 24 calculates a left tire speed command LTC by adding the body angle signal AS to the body target angle θcom and by multiplying what results from the addition by an acceleration/deceleration gain Ga. Additionally, the output speed calculation processing module 24 calculates a right tire speed command RTC by deducting the body angle signal from the body target angle θcom and multiplying what results from the deduction by the acceleration/deceleration gain Ga.

The acceleration/deceleration gain Ga is an acceleration/deceleration command having an excessive value corresponding to a speed difference between the left and right tires. The left tire speed command LTC and the right tire speed command RTC are a first speed command value corresponding to a deviation of the current position of the automated guided vehicle AGV from a target position on the magnetic guide marker.

The output speed calculation processing module 24 calculates a forced speed command FSC based on a left and right tire command speed mean ATC which is a mean value of the command speeds represented by the left tire speed command LTC and the right tire speed command TRC, a left and right tire actual speed mean ATS which is a mean value of the left tire actual speed LAS and the right tire actual speed RAS, and the body position sensor signal BPS.

This forced speed command FSC is a second speed command value corresponding to a displacement of the center axis of the body of the automated guided vehicle AGV with respect to the magnetic guide marker MG.

The output speed calculation processing module 24 calculates a left speed command LSC by adding the forced speed command FSC to the left tire speed command LTC and deducting the left tire actual speed LAS from what results from the addition. The output speed calculation processing module 24 calculates a right speed command RSC by adding the forced speed command FSC to the right tire speed command RTC and deducting the right tire actual speed RAS from what results from the addition.

The left speed command LSC and the right speed command RSC are command values for the motors which are calculated by adding the first speed command value (the left tire speed command LTC and the right tire speed command RTC), the second speed command value (the forced speed command FSC) and the respective actual speeds of the left and right tires.

Assuming that positional deviation gain=K1× positional deviation amount B, and acceleration/deceleration gain=K2×abs (mean value of the speed commands of the left and right tires−mean value of the actual speeds of the left and right tires), the left speed command LSC and the right speed command RSC are expressed by the following expressions (1) and (2). K1 and K2 are constants which are determined according to the specification of the automated guided vehicle AGV.

(1) Left speed command LSC=(Body speed command SC)×(1+Positional deviation gain× Acceleration/deceleration gain)

(2) Right speed command RSC=(Body speed command SC)×(1−Positional deviation gain× Acceleration/deceleration gain)

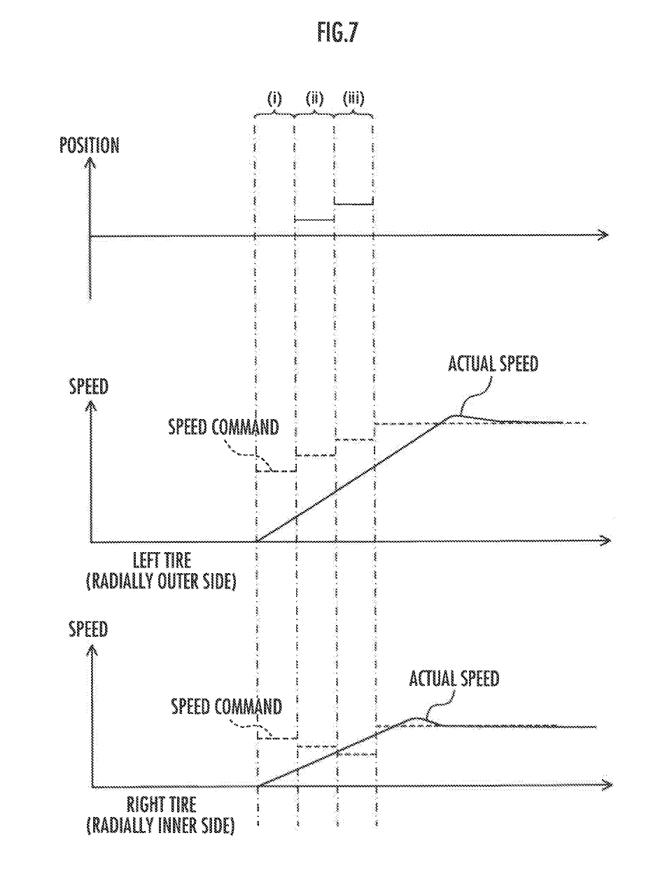

FIG. 7 is a graph showing schematically a relationship among the position of the automated guided vehicle AGV, the left speed command LSC, the actual speed of the left tire, the tight speed command RSC, and the actual speed of the right tire when the automated guided vehicle AGV runs on a rightward curve. The motor control system 100 of this embodiment switches between the left speed command LSC and the right speed command RSC every predetermined period of time ((i) to (iii) in the figure) after the automated guided vehicle AGV enters the curve.

For example, for the left tire which is a tire positioned on a radially outer side of the curve, the motor control system 100 controls so that the value of the left speed command LSC is increased step by step at the periods of time (i) to (iii). Then, the motor control system 100 increases the left speed command. LSC to a value corresponding to an upper limit of acceleration after the periods of time (i) to (iii). The upper limit of acceleration is determined according to the response characteristic of the motor in relation to acceleration/deceleration. This enables the radially outer side tire to act quickly.

On the other hand, for the right tire which is a tire positioned on a radially inner side of the curve, the motor control system 100 controls so that the value of the right speed command RSC is decreased step by step at the periods of time (i) to (iii). That is, at a curved path such as a curve or the like, in case the same acceleration or deceleration command is inputted in the motor which drives the radially inner side tire, the motor is always caused to stay in an accelerating state. Then, the motor control system 100 puts the radially inner side tire in a decelerated state at the periods of time (ii) and (iii) by setting the command for the radially inner side tire to be lower than the actual speed. This reduces the command value for the radially inner side tire more as the positional deviation becomes larger, whereby a returning action of returning the body target angle θcom which is put in a low speed state works. Due to the existence of a viscous component to the tire, resulting in large friction, a frequency responsiveness of the right tire which is decelerated is higher than a frequency responsiveness of the left tire which is accelerated. That is, the output speed calculation processing module 24 calculates speed command values LSC and RSC for the pair of motors by setting a large acceleration/deceleration gain for the tire positioned on the radially outer side of the curved path of the left and right tires and a small acceleration/deceleration gain for the tire positioned on the radially inner side of the curved path.

A frequency at which the left and right speed commands are updated is preferably f×10 times or larger, where f is a speed response of the motors (for example, 0.5 Hz). That is, when the frequency response of the motors is 0.5 Hz, the motor control system 100 executes a control at a frequency of 100 Hz, for example. This is because a wasteful time between signals affects the phase margin of the vehicle.

Thus, as has been described heretofore, when the automated guided vehicle AGV is traveling in the direction in which the automated guided vehicle travels away from the magnetic guide marker MG, the motor control system 100 of this embodiment executes the two-stage control in which the traveling direction of the automated guided vehicle AGV is controlled first to become parallel to the magnetic guide marker MG, and then, the automated guided vehicle AGV is shifted onto the magnetic guide marker MG from the state where the automated guided vehicle AGV is parallel to the magnetic guide marker MG. According to this configuration, being different from a case where the automated guided vehicle AGV traveling in the direction in which the automated guided vehicle AGV travels away from the magnetic guide marker MG is attempted to be shifted onto the magnetic guide marker MG, a large inertia is not generated which would otherwise be generated by a drastic change in the traveling direction of the vehicle. Consequently, the automated guided vehicle AGV can be prevented from deviating from the guide path. Additionally, since the speed of the automated guided vehicle AGV does not have to be suppressed to a low level to prevent the deviation from the guide path, the automated guided vehicle AGV can be prevented from deviating from the guide path while being allowed to act quickly. In addition, in the second stage control, the traveling direction of the automated guided vehicle AGV is controlled to gradually coincide with the extending direction of the magnetic guide marker MG as the automated guided vehicle AGV approaches the magnetic guide marker MG. Because of this, being different from a case where the traveling direction of the automated guided vehicle ACV is controlled drastically to shift the automated guided vehicle AGV onto the magnetic guided marker MG, the oscillating state of the automated guided vehicle AGV is not generated. Consequently, the automated guided vehicle AGV can be prevented from deviating from the guide path due to the oscillation of the body.

The motor control system 100 of this embodiment controls the body of the automated guided vehicle AGV to turn by feedback controlling the body angle signal AS to the left and the right depending on the difference in polarity using the body target angle θcom as a control target. Additionally, the motor control system 100 calculates speed command values for the left and right motors by inputting forced tracing speed command values in addition to the feedback control. Because of this, being different from a case where speed command values for the motors are calculated only through the feedback control, a speed command can be executed which is equal to or faster than the response characteristic of the motors. Consequently, the control to prevent the deviation of the automated guided vehicle from the guide path can be realized while suppressing the deceleration of the body to a minimum level by inputting the steep speed command into the motors.

In the motor control system 100 of this embodiment, when the automated guided vehicle AGV runs on the curved path such as a curve, the output speed calculation processing module 24 calculates the speed command values for the pair of motors by setting the large acceleration/deceleration gain for the tire positioned on the radially outer side of the curved path of the left and right tires and the small acceleration/deceleration gain for the tire positioned on the radially inner side of the curved path. This increases the change in speed of the radially outer side tire while decreasing the change in speed of the radially inner side tire, whereby the automated guided vehicle can be made to act with a smaller turning radius when running on the curved path such as a curve. Thus, since the responsiveness of the body can be enhanced, the automated guided vehicle can run quickly.

Consequently, according to the motor control system 100 of this embodiment, the automated guided vehicle AGV can be restrained from deviating from the guide path while being allowed to act quickly.

The embodiment of the invention is not limited to the embodiment described above. For example, in the embodiment described above, the magnetic guide sensor is described as being configured as the magnetic sensor array made up of 15 magnetic sensors, and these 15 magnetic sensors are described as being aligned into the row extending in the direction at tight angles to the center axis CA of the body. However, the number and arrangement of the magnetic sensor are not limited to those described in the embodiment.

The shape of the magnetic guide marker MG is not limited to the tape-like shape, and hence, the magnetic guide marker MG may be laid out on the surface of the path in such a way as to guide the vehicle along the operation route. For example, the magnetic guide marker MG may be configured by disposing rectangular, circular or elliptic magnetic markers at predetermined intervals into chain line. As this occurs, the direction of the chain line becomes the extending direction of the magnetic guide markers.

In the embodiment described above, the guide marker indicating the operation route is described as being the magnetic guide marker, and the guide sensor configured to detect the guide marker is described as being the magnetic guide sensor. However, the guide marker and the guide sensor are not limited to those making use of magnetism. For example, a configuration may be adopted in which the guide marker is formed of a paint and the guide sensor is configured to detect the guide marker optically.

In the embodiment described above, the automated guided vehicle AGV is described as running on the rightward curve, and the control of the motors on the radially outer side and radially inner side of the curved path (speed commands) is described. However, for a case where the automated guided vehicle AGV runs on a leftward curve, too, a similar control can be executed by switching the controls made on the left and right motors (the control made on the radially outer side and radially inner side motors).

Additionally, a similar motor control to those described above can also be executed even when the automated guided vehicle AGV runs on other curved paths requiring the different control on the radially inner side and the radially outer side, such as when the automated guided vehicle AGV takes a right turn or a left turn, as well as the case of running on the curve.

What is claimed is:

1. An automated guided vehicle running along a guide marker, the automated guided vehicle comprising:
a body;
left and right tires;
a guide sensor provided on the body and configured to detect the guide marker; and
a drive unit configured to drive the left and right tires,
wherein the drive unit executes
a first control in which the left and fight tires are driven so that the automated guided vehicle travels in a direction parallel to an extending direction of the guide marker in a case where the automated guided vehicle travels in a direction in which the automated guided vehicle travels away from the guide marker, and
a second control in which the left and right tires are driven so that a reference position on the body of the automated guided vehicle shifts onto the guide marker and that the automated guided vehicle travels along the guide marker in a case where the automated guided vehicle travels in a direction parallel to the extending direction of the guide marker or travels in a direction in which the automated guided vehicle travels towards the guide marker.

2. The automated guided vehicle according to claim 1,
wherein in the second control, the drive unit drives the left and right tires so that an angle formed by the traveling direction of the automated guided vehicle and the extending direction of the guide marker decreases according to a distance between the body of the automated guided vehicle and the guide marker.

3. The automated guided vehicle according to claim 1,
wherein the drive unit comprises:
a pair of motors configured to drive the left and right tires;
a body position detection unit configured to obtain a body angle signal indicating a change in a position of the body of the automated guided vehicle with respect to the guide marker;
a speed command calculation unit configured to set a target angle of the body and calculate speed command values for the left and right tires based on the set target angle of the body and the body angle signal; and
an output speed calculation processing unit configured to calculate speed command values for the pair of motors based on the speed command values of the left and right tires.

4. The automated guided vehicle according to claim 3,
wherein the output speed calculation processing unit calculates a forced tracing speed command value based on a mean of actual speeds of the left and right tires, the position of the body of the automated guided vehicle with respect to the guide marker and a mean of speed command values of the left and right tires, and calculates speed command values for the pair of motors based on the speed command values of the left and right tires, the forced tracing speed command value, and the actual speeds of the left and right tires.

5. The automated guided vehicle according to claim 3,
wherein when the automated guided vehicle runs on a curved path, the output speed calculation processing unit calculates the speed command values for the pair of motors by setting a large acceleration/deceleration gain for the tire of the left and tight tires positioned on a radially outer side of the curved path and a small acceleration/deceleration gain for the tire positioned on a radially inner side of the curved path.
